(19) United States
(12) Patent Application Publication
(10) Pub. No.: US 2025/0326275 A1
(43) Pub. Date: Oct. 23, 2025

(54) AIR REGISTERS INCLUDING A FIXED BLADE AND ROTATING BARRELS

(71) Applicant: Toyoda Gosei Co., Ltd., Kiyosu-shi (JP)

(72) Inventors: Roy Thorsell, Wixom, MI (US); Hideki Okigawa, Novi, MI (US)

(73) Assignee: Toyoda Gosei Co., Ltd., Kiyosu-shi (JP)

(21) Appl. No.: 18/642,035

(22) Filed: Apr. 22, 2024

(51) Int. Cl. B60H 1/34

(52) U.S. Cl. CPC B60H 1/3414; B60H 2001/3471

(57) ABSTRACT

An air register including a housing, a blade member provided within the housing and defining a plurality of upper air channels and a plurality of lower air channels, an outer barrel having a plurality of outer openings, the outer barrel rotatable relative to the housing to align one or more of the plurality of outer openings with one or more of the plurality of upper air channels and one or more of the plurality of lower air channels, and an inner barrel having a plurality of inner openings, the inner barrel rotatable relative to the housing to align one or more of the plurality of inner openings with one or more of the plurality of upper air channels and one or more of the plurality of lower air channels.

### TECHNICAL FIELD

The present specification generally relates to air registers for vehicles and, more specifically, air registers having adjustable internal, rotating barrels for directing airflow.

### BACKGROUND

Air registers in vehicles typically include a plurality of vertical vanes that are selectively adjustable to direct airflow in a plurality of directions in a width direction and/or a lateral direction of the vehicle. For example, the vertical vanes may be oriented toward the left to direct airflow to the left and to the right to direct airflow to the right. However, this results in numerous moving components to facilitate each vertical vane being simultaneously rotated. Additionally, as air flows through the air register, some of the air may contact a side wall of the air register and be redirected out of the air register. This redirected air affects a flow direction of the remaining air flowing through the air register such that a cumulative angle at which the air flows through the air register is not aligned with a selected direction of the vertical air blades. Rather, the air flows more toward a center of the air register rather than the selected direction.

Accordingly, a need exists for improved air registers that provides fewer moving parts and more accurate airflow through the air registers and, thus, a reduced risk of part failure, reduced manufacturing costs and, a greater range for which air may be directed out of the air registers.

### SUMMARY

In one embodiment, an air register includes a housing, a blade member provided within the housing and defining a plurality of upper air channels and a plurality of lower air channels, an outer barrel having a plurality of outer openings, the outer barrel rotatable relative to the housing to align one or more of the plurality of outer openings with one or more of the plurality of upper air channels and one or more of the plurality of lower air channels, and an inner barrel having a plurality of inner openings, the inner barrel rotatable relative to the housing to align one or more of the plurality of inner openings with one or more of the plurality of upper air channels and one or more of the plurality of lower air channels.

In another embodiment, a vehicle includes a dashboard and an air register provided within the dashboard, the air register including a housing, a blade member provided within the housing and defining a plurality of upper air channels and a plurality of lower air channels, an outer barrel having a plurality of outer openings, the outer barrel rotatable relative to the housing to align one or more of the plurality of outer openings with one or more of the plurality of upper air channels and one or more of the plurality of lower air channels, and an inner barrel having a plurality of inner openings, the inner barrel rotatable relative to the housing to align one or more of the plurality of inner openings with one or more of the plurality of upper air channels and one or more of the plurality of lower air channels.

In yet another embodiment, a method of operating an air register includes a housing, a blade member defining a plurality of upper air channels and a plurality of lower air channels, an outer barrel having a plurality of outer openings, and an inner barrel having a plurality of inner openings, the method including rotating the outer barrel relative to the housing to align one or more of the plurality of outer openings with one or more of the plurality of upper air channels and one or more of the plurality of lower air channels, and rotating the inner barrel relative to the housing to align one or more of the plurality of inner openings with one or more of the plurality of upper air channels and one or more of the plurality of lower air channels, wherein a volume and a direction of air exiting the blade member is selectively controllable based on a particular rotation position of the inner barrel and the outer barrel.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a partial front view of a passenger compartment a vehicle including a plurality of air registers, according to one or more embodiments shown and described herein;

FIG. 2 schematically depicts a perspective view of the air register, according to one or more embodiments shown and described herein;

FIG. 3 schematically depicts an exploded perspective view of the air register, according to one or more embodiments shown and described herein;

FIG. 4 schematically depicts a front view of the air register, according to one or more embodiments shown and described herein;

FIG. 5 schematically depicts a partial front view of the air register with a blade member removed, according to one or more embodiments shown and described herein;

FIG. 6A schematically depicts a cross-sectional view of the air register taken along line 6A-6A of FIG. 4, according to one or more embodiments shown and described herein;

FIG. 6B schematically depicts a cross-sectional view of the air register taken along line 6B-6B of FIG. 4, according to one or more embodiments shown and described herein;

FIG. 7 schematically depicts a partial rear perspective view of the air register, according to one or more embodiments shown and described herein;

FIG. 8A schematically depicts an elevated view of an outer barrel of the air register in a first rotation position, according to one or more embodiments shown and described herein;

FIG. 8B schematically depicts an elevated view of the outer barrel in a second rotation position, according to one or more embodiments shown and described herein;

FIG. 8C schematically depicts an elevated view of the outer barrel in a third rotation position, according to one or more embodiments shown and described herein;

FIG. 8D schematically depicts an elevated view of the outer barrel in a fourth rotation position, according to one or more embodiments shown and described herein;

FIG. 9A schematically depicts an elevated view of an inner barrel of the air register in a first rotation position, according to one or more embodiments shown and described herein;

FIG. 9B schematically depicts an elevated view of the inner barrel in a second rotation position, according to one or more embodiments shown and described herein;

FIG. 9C schematically depicts an elevated view of the inner barrel in a third rotation position, according to one or more embodiments shown and described herein;

FIG. 9D schematically depicts an elevated view of the inner barrel in a fourth rotation position, according to one or more embodiments shown and described herein;

FIG. 9E schematically depicts an elevated view of the inner barrel in a fifth rotation position, according to one or more embodiments shown and described herein;

FIG. 10A depicts a table indicating a volume of airflow through the outer barrel in Positions 1-5, according to one or more embodiments shown and described herein;

FIG. 10B depicts a table indicating a volume of airflow through the outer barrel in Positions 6-10, according to one or more embodiments shown and described herein;

FIG. 10C depicts a table indicating a volume of airflow through the outer barrel in Positions 11-15, according to one or more embodiments shown and described herein;

FIG. 10D depicts a table indicating a volume of airflow through the outer barrel in Positions 16-19, according to one or more embodiments shown and described herein;

FIG. 10E depicts a table indicating a volume of airflow through the outer barrel in Positions 20-23, according to one or more embodiments shown and described herein; and

FIG. 11 depicts a table indicating a volume of airflow through the inner barrel in Positions 1-5, according to one or more embodiments shown and described herein.

### DETAILED DESCRIPTION

Embodiments described herein are directed to air registers including a housing, a blade member provided within the housing and defining a plurality of upper air channels and a plurality of lower air channels, an outer barrel having a plurality of outer openings, the outer barrel rotatable relative to the housing to align one or more of the plurality of outer openings with one or more of the plurality of upper air channels and one or more of the plurality of lower air channels, and an inner barrel having a plurality of inner openings, the inner barrel rotatable relative to the housing to align one or more of the plurality of inner openings with one or more of the plurality of upper air channels and one or more of the plurality of lower air channels.

Various embodiments of the air register and the operation of the air register are described in more detail herein. Whenever possible, the same reference numerals will be used throughout the drawings to refer to the same or like parts.

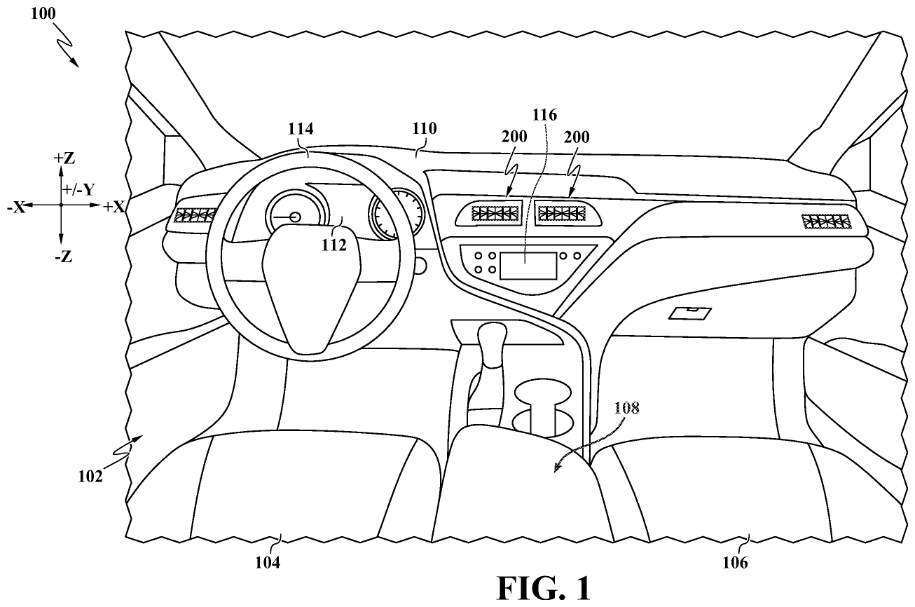

As used herein, the term “vehicle longitudinal direction” refers to the forward-rearward direction of the vehicle (i.e., in the +/−Y direction of the coordinate axes depicted in FIG. 1). The term “vehicle lateral direction” refers to the cross-vehicle direction (i.e., in the +/−X direction of the coordinate axes depicted in FIG. 1), and is transverse to the vehicle longitudinal direction. Specifically, “right” is defined as the positive X direction of the coordinate axes shown in the drawings, and “left” is defined as the negative X direction of the coordinate axes shown in the drawings. The term “vehicle vertical direction” refers to the upward-downward direction of the vehicle (i.e., in the +/−Z direction of the coordinate axes depicted in FIG. 1). As used herein, “upper” and “above” are defined as the positive Z direction of the coordinate axes shown in the drawings. “Lower” and “below” are defined as the negative Z direction of the coordinate axes shown in the drawings. As used herein, the term “rotation direction” refers to a clockwise rotation direction when viewed from a top plan view. Similarly, as used herein, the term “counter-rotation direction” refers to a counter-clockwise rotation direction when viewed from a top plan view.

Referring now to FIG. 1, a vehicle 100 is partially illustrated according to one or more embodiments described herein. The vehicle 100 includes a passenger compartment 102 in which a driver seat 104 and a front passenger seat 106 are provided with a center console 108 provided therebetween. The vehicle 100 includes a dashboard 110 provided in front of the driver seat 104 and the front passenger seat 106. An instrument panel 112 is provided within the dashboard 110 and a steering wheel 114 is provided in front of the driver seat 104 extending in front of the instrument panel 112. As shown, the vehicle 100 includes a plurality of air registers 200 provided within the dashboard 110. However, it should be appreciated that the location of the air registers 200 is not limited to the specific location illustrated in FIG. 1. Rather, one or more air registers 200 may alternatively or additionally be provided at any other suitable location of the vehicle 100 such as, for example, in a rear portion of the passenger compartment 102 of the vehicle 100 located behind the driver seat 104 and the front passenger seat 106, on a side door of the vehicle 100, on the rear of the center console 108, and the like.

As shown in FIG. 1, the vehicle 100 is provided as an automobile which includes coupes, sedans, minivans, trucks, crossovers, hybrids, and sports utility vehicles. However, the air register 200 is not limited to automobiles. In embodiments, the air register 200 may be provided in any vehicle such as a watercraft, aircraft, or the like.

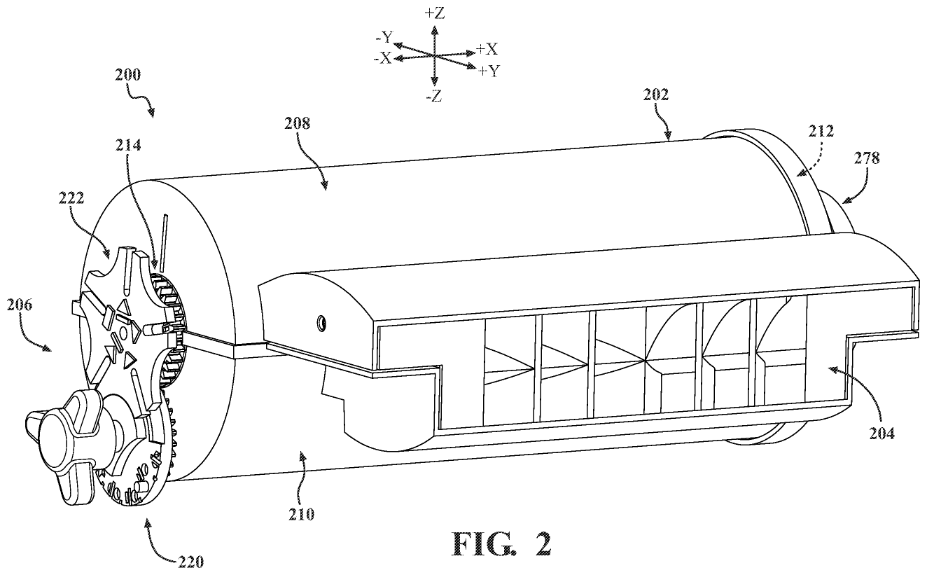

Referring now to FIG. 2, one of the air registers 200 of the vehicle 100 of FIG. 1 is shown separate from the vehicle 100 itself. The air register 200 generally includes a housing 202, a blade member 204, and an actuation mechanism 206. As shown, the housing 202 includes an upper housing member 208 and a lower housing member 210. The blade member 204 is housed between the upper housing member 208 and the lower housing member 210. An air inlet 212 is formed in an end of the housing 202 such that a flow path may be provided for air to flow through the housing 202, specifically, through the air inlet 212 into the housing 202 and through the blade member 204 out of the housing 202. An actuation opening 214 is formed in an end of the housing 202 opposite the air inlet 212.

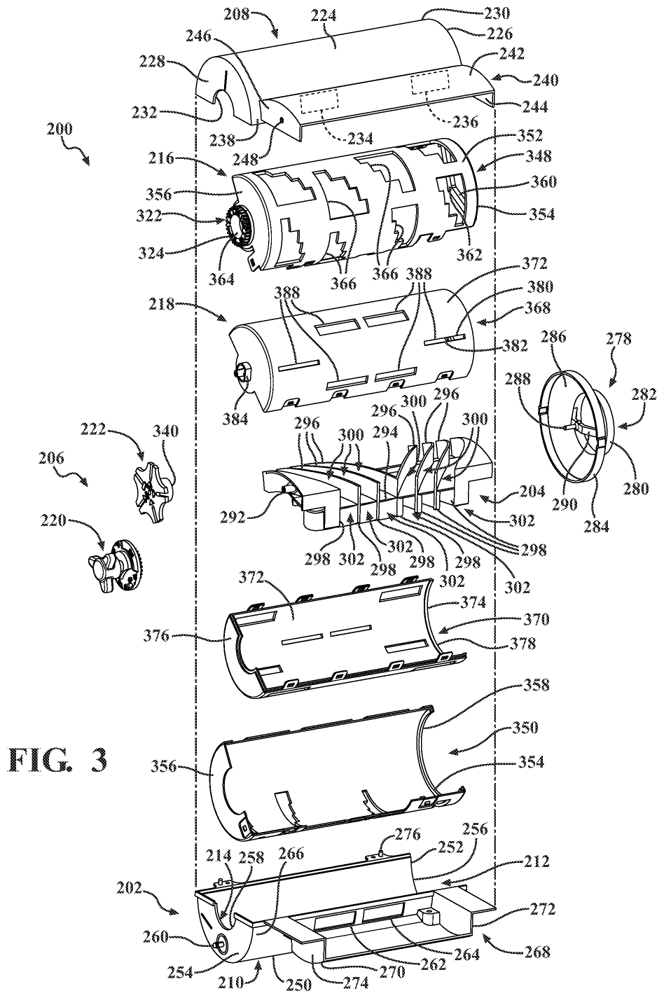

The actuation mechanism 206 is provided at the actuation opening 214 formed in the opposite end of the housing 202 and configured to rotate an outer barrel 216 and an inner barrel 218 (FIG. 3) provided within the housing 202, as described in more detail herein. In embodiments, the actuation mechanism 206 is a Geneva drive including a drive wheel 220 coupled to the outer barrel 216 and a driven wheel 222 coupled to the inner barrel 218. As described herein, rotation of the drive wheel 220 results in incremental rotation of the driven wheel 222.

Referring now to FIG. 3, an exploded view of the air register 200 is illustrated. As shown, the air register 200 generally includes the housing 202, the blade member 204, the outer barrel 216, the inner barrel 218, and the drive wheel 220 and the driven wheel 222 of the actuation mechanism 206 coupled to the outer barrel 216 and the inner barrel 218, respectively. As noted above, the housing 202 includes the upper housing member 208 and the lower housing member 210.

The upper housing member 208 includes an upper wall 224 having a first end wall 226 and a second end wall 228 opposite the first end wall 226. A first opening 230 is formed in the first end wall 226 of the upper housing member 208, which partially defines the air inlet 212 (FIG. 2). A second opening 232 is formed in the second end wall 228 of the upper housing member 208. As shown, the upper wall 224 has an arcuate shape corresponding to a shape of the outer barrel 216. However, the upper wall 224 of the upper housing member 208 may have any suitable shape so as to accommodate the outer barrel 216. As shown in FIG. 5, a first upper air outlet 234 and a second upper air outlet 236 are formed in a front portion 238 of the upper wall 224 of the upper housing member 208. The first upper air outlet 234 and the second upper air outlet 236 are spaced apart from one another by a first distance D1.

Referring again to FIG. 3, the upper housing member 208 further includes an upper blade receiver 240 extending from the front portion 238 of the upper wall 224. The upper blade receiver 240 has an upper wall 242, a first end wall 244, and a second end wall 246 extending from opposite ends of the upper wall 242. The upper wall 242 of the upper blade receiver 240 has an arcuate shape corresponding to a shape of the blade member 204, as described in more detail herein. In embodiments, an aperture 248 is formed in each of the first end wall 244 and the second end wall 246 of the upper blade receiver 240 to facilitate engagement with the blade member 204.

The lower housing member 210 has similar structure to the upper housing member 208. Specifically, the lower housing member 210 includes a lower wall 250 having a first end wall 252 and a second end wall 254 opposite the first end wall 252. A first opening 256 is formed in the first end wall 252 of the lower housing member 210, which cooperates with the first opening 230 formed in the first end wall 244 of the upper housing member 208 to define the air inlet 212. A second opening 258 is formed in the second end wall 254 of the lower housing member 210, which cooperates with the second opening 232 formed in the second end wall 228 of the upper housing member 208 to define the actuation opening 214. In embodiments, a post 260 extends outwardly from the second end wall 254 and is at least partially received within the drive wheel 220. The engagement of the post 260 and the drive wheel 220 rotatably supports the drive wheel 220 while maintaining an axial position of the drive wheel 220. As shown, the lower wall 250 has an arcuate shape corresponding to the shape of the outer barrel 216. However, the lower wall 250 of the lower housing member 210 may have any suitable shape so as to accommodate the outer barrel 216.

As shown in FIGS. 3 and 5, a first lower air outlet 262 and a second lower air outlet 264 are formed in a front portion 266 of the lower wall 250 of the lower housing member 210. The first lower air outlet 262 and the second lower air outlet 264 are spaced apart from one another by a second distance D2. In embodiments, the second distance D2 is less than the first distance D1. In other embodiments, the second distance D2 is greater than the first distance D1. In other embodiments, the second distance D2 is equal to the first distance D1. Referring again to FIG. 3, the lower housing member 210 further includes a lower blade receiver 268 extending from the front portion 266 of the lower wall 250. The lower blade receiver 268 has a lower wall 270, a first end wall 272, and a second end wall 274 extending from opposite ends of the lower wall 270. The lower wall 270 of the lower blade receiver 268 has an arcuate shape corresponding to a shape of the blade member 204, as described in more detail herein. Although not depicted, in embodiments, the aperture 248 formed in each of the first end wall 244 and the second end wall 246 of the upper blade receiver 240 may alternatively be formed, or additional apertures formed, in the lower blade receiver 268 to facilitate engagement with the blade member 204.

The upper housing member 208 and the lower housing member 210 may be joined in any suitable manner such as by, for example, fasteners, clips, brackets, and the like. Although the upper housing member 208 and the lower housing member 210 are depicted as two separate components, it should be appreciated that the upper housing member 208 and the lower housing member 210 may be an integrally formed, one-piece component. In embodiments in which the lower housing member 210 is attached to the upper housing member 208, the lower housing member 210 includes one or more fasteners 276 for engaging the upper housing member 208. As shown, the fasteners 276 are provided to engage the upper housing member 208. However, in other embodiments, the fasteners 276 may be provided on the upper housing member 208 to engage the lower housing member 210.

Referring still to FIG. 3, a cap 278 is provided at an end of the housing 202 opposite the actuation mechanism 206 to further secure the upper housing member 208 to the lower housing member 210. The cap 278 further serves to taper the size of the air inlet 212. Accordingly, in embodiments, the cap 278 has an inner rim 280 defining an opening 282 through which air flows through the cap 278 and into the housing 202, and an outer rim 284 circumscribing the housing 202. A cap wall 286 extends between the inner rim 280 and the outer rim 284. The outer rim 284 has a diameter greater than a diameter of the inner rim 280 such that the cap wall 286 tapers from the outer rim 284 toward the inner rim 280. In embodiments, a stabilizing pin 288 extends axially inwardly from a bridge 290 extending across the inner rim 280. As described herein, in embodiments, the stabilizing pin 288 engages the outer barrel 216 and/or the inner barrel 218 to rotatably support and stabilize the outer barrel 216 and the inner barrel 218, respectively, during rotation.

As noted above, the blade member 204 is provided between the upper blade receiver 240 and the lower blade receiver 268. However, in embodiments, the blade member 204 is formed with the upper housing member 208 and the lower housing member 210 as an integrally formed, one-piece component. In embodiments in which the blade member 204 is separately attached to the housing 202, the blade member 204 includes a pin 292 extending from one or both ends of the blade member 204. The pin 292 is extendable through the apertures 248 formed in the upper blade receiver 240 to secure the blade member 204 to the housing 202. However, the blade member 204 may be secured to the housing 202 in any other suitable member.

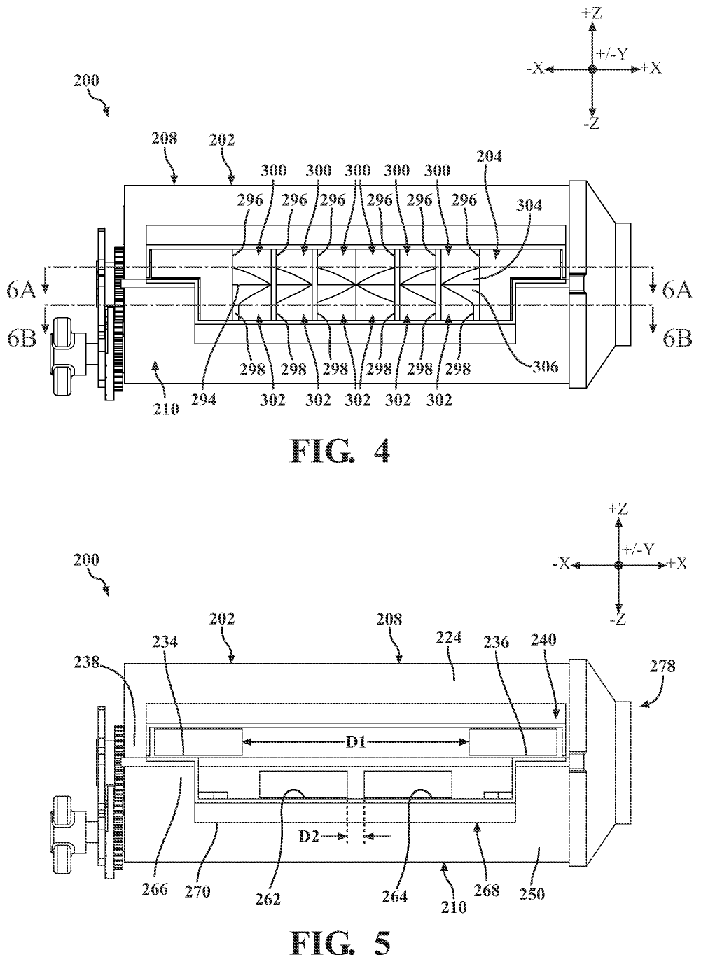

As shown in FIGS. 3 and 4, the blade member 204 includes a central wall 294, a plurality of upper vanes 296 extending vertically from the central wall 294 in an upward vehicle vertical direction, and a plurality of lower vanes 298 extending vertically from the central wall 294 in a downward vehicle vertical direction. The upper vanes 296 define a plurality of upper air channels 300, and the lower vanes 298 define a plurality of lower air channels 302. Referring to FIG. 4, the central wall 294 has an upper surface 304 and a lower surface 306 opposite the upper surface 304. The upper surface 304 and the lower surface 306 each has an arcuate shape curving in opposite directions. Accordingly, airflow out of the blade member 204 through the upper air channels 300 is directed in the downward vehicle vertical direction, and airflow out of the blade member 204 through the lower air channels 302 is directed in the upward vehicle vertical direction.

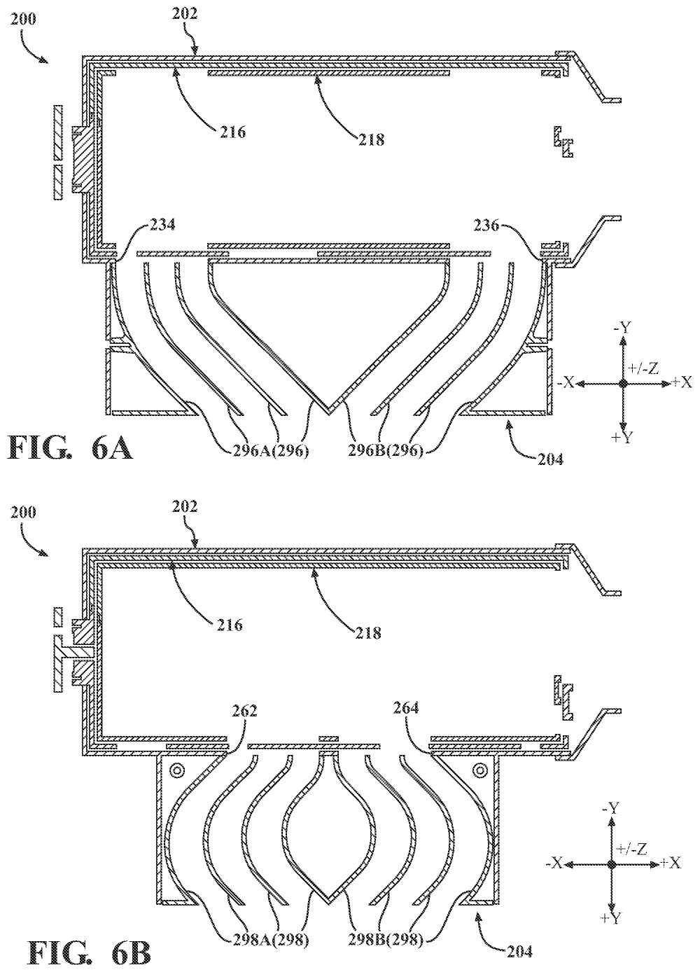

Referring now to FIG. 6A, a cross-sectional view of the air register 200 is shown taken along line 6A-6A of FIG. 4 to illustrate a contour of the upper vanes 296. The upper vanes 296 include a first subset of upper vanes 296A extending from the first upper air outlet 234, and a second subset of upper vanes 296B extending from the second upper air outlet 236. The first subset of upper vanes 296A have an arcuate shape curving in a first direction from the first upper air outlet 234, and the second subset of upper vanes 296B have an arcuate shape curving in a second direction from the second upper air outlet 236 opposite the first direction. Accordingly, the first subset of upper vanes 296A are mirror images of the second subset of upper vanes 296B about the Y-axis of the coordinate axes depicted in the drawings. Thus, airflow out of the blade member 204 through the upper air channels 300 defined by the first subset of upper vanes 296A is directed in a first or right vehicle lateral direction, and airflow out of the blade member 204 through the upper air channels 300 defined by the second subset of upper vanes 296B is directed in an opposite second or left vehicle lateral direction. It should be appreciated that any number of upper vanes 296 may be provided other than that depicted herein.

Referring now to FIG. 6B, a cross-sectional view of the air register 200 is shown taken along line 6B-6B of FIG. 4 to illustrate a contour of the lower vanes 298. The lower vanes 298 include a first subset of lower vanes 298A extending from the first lower air outlet 262, and a second subset of lower vanes 298B extending from the second lower air outlet 264. The first subset of lower vanes 298A have an arcuate shape curving in the first direction from the first lower air outlet 262, and the second subset of lower vanes 298B have an arcuate shape curving in the second direction from the second lower air outlet 264 opposite the first direction. Accordingly, the first subset of lower vanes 298A are mirror images of the second subset of lower vanes 298B about the Y-axis. Thus, airflow out of the blade member 204 through the lower air channels 302 defined by the first subset of lower vanes 298A is directed in the first or right vehicle lateral direction, and airflow out of the blade member 204 through the lower air channels 302 defined by the second subset of lower vanes 298B is directed in an opposite second or left vehicle lateral direction. It should be appreciated that any number of lower vanes may be provided other than that depicted herein.

Additionally, when comparing the curvature of the upper vanes 296 depicted in FIG. 6A with the lower vanes 298 depicted in FIG. 6B, it should be appreciated that the first subset of upper vanes 296A and the first subset of lower vanes 298A terminate at an angular orientation equal to one another. Accordingly, the first subset of upper vanes 296A and the first subset of lower vanes 298A each direct airflow in the same vehicle lateral direction. Similarly, the second subset of upper vanes 296B and the second subset of lower vanes 298B terminate at an angular orientation equal to one another. Accordingly, the second subset of upper vanes 296B and the second subset of lower vanes 298B each direct airflow in the same vehicle lateral direction.

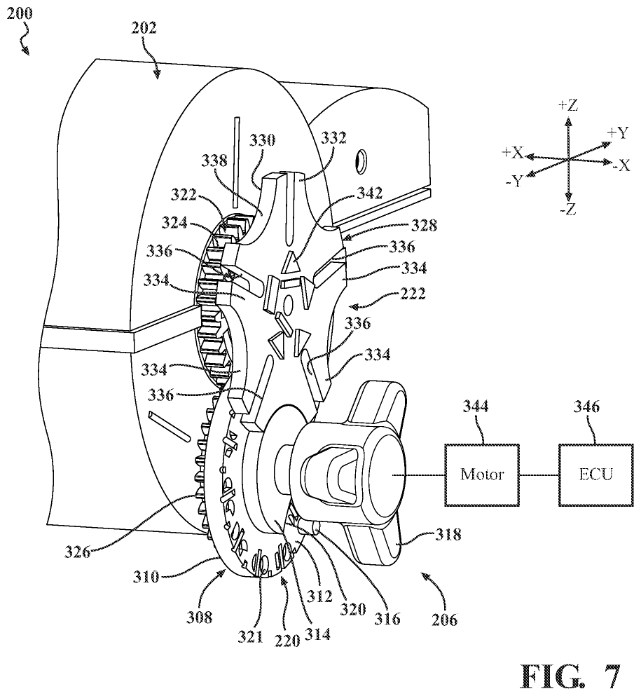

Referring now FIG. 7, the actuation mechanism 206 is shown including the drive wheel 220 and the driven wheel 222. The drive wheel 220 includes a drive gear 308 having an inner surface 310 and an outer surface 312 opposite the inner surface 310, a circular disc 314 provided on the outer surface 312 of the drive gear 308, and a pin 316 provided on the outer surface 312 of the drive gear 308. In embodiments, the drive wheel 220 includes a protrusion 318 extending from the circular disc 314 in a direction opposite the inner surface 310. The circular disc 314 has a cutout 320 formed therein to facilitate rotation of the driven wheel 222, as discussed in more detail herein. In embodiments, the drive wheel 220 further includes indicia 321 provided on the outer surface indicating a particular rotation position of the outer barrel 216 (FIG. 3) based upon a corresponding position of the drive wheel 220. As described in more detail herein, the outer barrel 216 includes a fixed gear 322 having a plurality of teeth 324 provided at an end of the outer barrel 216. A plurality of teeth 326 of the drive wheel 220 of the drive gear 308 engages the plurality of teeth 324 of the fixed gear 322 of the outer barrel 216 such that rotation of the drive wheel 220 results in a predetermined rotation ratio of the drive wheel 220 and the outer barrel 216. In embodiments, the predetermined rotation ratio is 1:1 in which one rotation of the drive wheel results in one rotation of the outer barrel 216. In embodiments, the drive gear 308 is rotatably supported by the post 260 of the lower housing member 210 (FIG. 3) to secure the axial position of the drive gear 308.

Referring still to FIG. 7, the driven wheel 222 includes a body 328 having an inner surface 330 and an outer surface 332. The body 328 defines a predetermined number of spokes 334 and a slot 336 is formed within each spoke 334 resulting in a predetermined number of slots 336. The body 328 between the spokes 334 has a concave perimeter surface 338 extending between adjacent spokes 334. As shown in the illustrated embodiment, the body 328 defines five spokes 334 and thus five slots 336. However, it should be appreciated that the body 328 may include any number of spokes 334 and slots 336. The number of spokes 334 and slots 336 corresponds to the number of times the driven wheel 222 will rotate with each complete rotation of the drive wheel 220 before the driven wheel 222 completes an entire 360 degree rotation. The driven wheel 222 further includes a shaft 340 (FIG. 3) extending from the inner surface 330 of the body 328 in a direction opposite the outer surface 332 of the body 328. As described in more detail herein, the shaft 340 is fixed to an end of the inner barrel 218 such that rotation of the driven wheel 222 results in corresponding 1:1 ratio of rotation of the inner barrel 218 in which one rotation of the driven wheel 222 results in one rotation of the inner barrel 218. In embodiments, the body 328 of the driven wheel 222 further includes indicia 342 provided on the outer surface 332 indicating a particular rotation position of the inner barrel 218 (FIG. 3) based upon a corresponding position of the driven wheel 222.

During rotation of the drive wheel 220, which may be operated by any suitable motor or the like, as described in more detail herein, the circular disc 314 rotates against the concave perimeter surface 338 of the driven wheel 222, which initially remains fixed. Once the drive wheel 220 is rotated such that the pin 316 is inserted into one of the slots 336, the pin 316 moves through the slot 336 causing the driven wheel 222 to rotate. The cutout 320 formed in the circular disc 314 of the drive wheel 220 permits the driven wheel 222 to rotate without interference by the circular disc 314 itself. Upon further rotation of the drive wheel 220, the pin 316 exits the slot 336 and rotation of the driven wheel 222 ceases despite continued rotation of the drive wheel 220. Accordingly, with each complete 360 degree rotation of the drive wheel 220, the driven wheel 222 incrementally rotates based on the predetermined number of slots 336. In the present embodiment with the driven wheel 222 including five slots 336, each incremental rotation of the driven wheel 222 equals a 72 degree rotation of the driven wheel 222 with each complete 360 degree rotation of the drive wheel 220. As such, rotation of the drive gear 308 and the outer barrel 216 (FIG. 3) results in a 5:1 ratio of rotation of the driven wheel 222 and the inner barrel 218 (FIG. 3).

Referring still to FIG. 7, a motor 344 may be communicatively coupled to the drive gear 308, such as via the protrusion 318 to rotate the drive gear 308. The motor 344 may be operated in response to receiving a signal from an electronic control unit 346. The electronic control unit 346 includes one or more processors and one or more memory modules. Each of the one or more processors may be any device capable of executing machine readable and executable instructions. Accordingly, each of the one or more processors may be a controller, an integrated circuit, a microchip, a computer, or any other computing device. The one or more memory modules may comprise RAM, ROM, flash memories, hard drives, or any device capable of storing machine readable and executable instructions such that the machine readable and executable instructions can be accessed by the one or more processors. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

The electronic control unit 346 may be communicatively coupled to any suitable device or component of the vehicle 100. For example, the electronic control unit 346 may be communicatively coupled to a human machine interface (HMI) 116 such as an infotainment system in the dashboard 110 operable by a passenger of the vehicle 100 to indicate a particular volume and/or direction of air. In response to receiving input from the passenger at the HMI 116 the electronic control unit 346 is configured to send a signal to the motor 344, which is operated to rotate the drive wheel 220, and thus the driven wheel 222, to position the outer barrel 216 and the inner barrel 218 to a particular rotation position, as described in more detail herein. In embodiments, the motor 344 may be incorporated into the protrusion 318 extending from the circular disc 314.

Referring again to FIG. 3, the outer barrel 216 is shown including a first outer barrel member 348 and a second outer barrel member 350. The first outer barrel member 348 and the second outer barrel member 350 may be joined in any suitable manner such as by, for example, fasteners, clips, brackets, and the like. Although the first outer barrel member 348 and the second outer barrel member 350 are depicted as two separate components, it should be appreciated that the first outer barrel member 348 and the second outer barrel member 350 may be an integrally formed, one-piece component. The outer barrel 216 includes an outer barrel body 352 having a first end wall 354 and a second end wall 356. As shown in FIG. 3, an opening 358 is formed in the first end wall 354 to permit air to enter the outer barrel 216. A reinforcement rib 360 extends across the opening 358 and an aperture 362 is formed in the reinforcement rib 360 to permit the stabilizing pin 288 extending from the cap 278 to rotatably secure the outer barrel 216. The fixed gear 322 is provided on the second end wall 356. An opening 364 is formed within the fixed gear 322 to permit the shaft 340 of the driven wheel 222 to extend through the fixed gear 322 and engage the inner barrel 218.

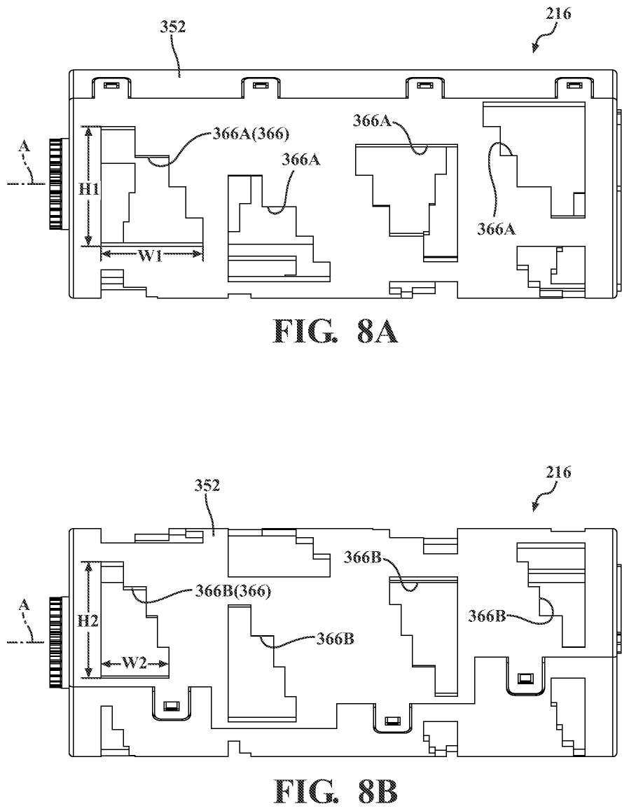

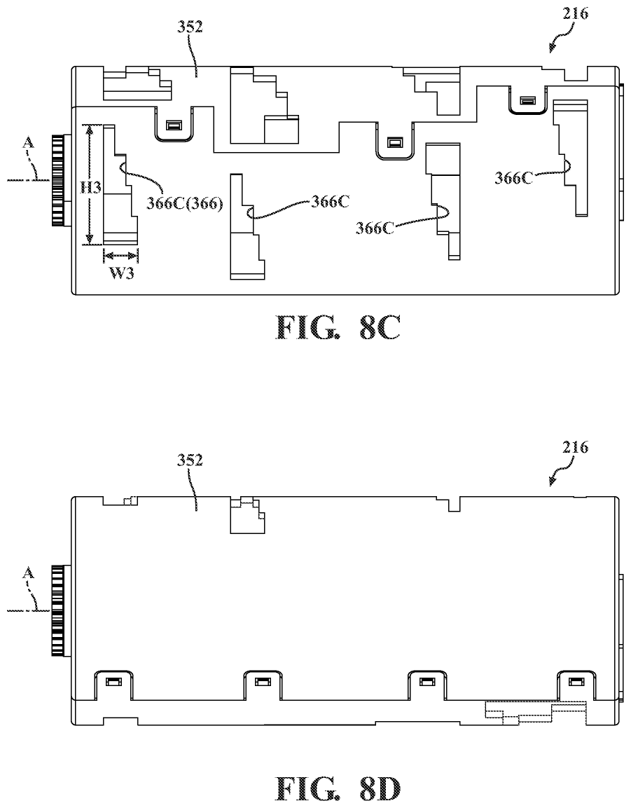

Referring now to FIGS. 8A-8D, the outer barrel 216 is shown in various rotation positions. As noted herein, the outer barrel 216 includes the fixed gear 322 and is rotatable about a rotation axis A, which extends generally parallel to the X-axis of the coordinate axes depicted in the drawings. A plurality of outer openings 366 are formed in the outer barrel body 352 through which air may be permitted to flow through to exit the outer barrel 216 when aligned with one or both of the upper air outlets 234, 236 or the lower air outlets 262, 264. The outer openings 366 formed in the outer barrel body 352 include a first array of outer openings 366A (FIG. 8A), a second array of outer openings 366B (FIG. 8B), and a third array of outer openings 366C (FIG. 8C), collectively referred to as the outer openings 366. As shown, the arrays of outer openings 366A-366C each includes four distinct outer openings 366. Additionally, the outer openings 366 each define a stepwise shape. However, it should be appreciated that the number and shape of the outer openings 366 is not limited to that illustrated herein. Accordingly, in other embodiments, the outer openings 366 may include a right triangle shape providing more gradual transitions along each of the outer openings 366. As the outer barrel 216 rotates about the rotation axis A, different portions of the outer openings 366 are aligned with one or both of the upper air outlets 234, 236 or the lower air outlets 262, 264 to control the volume and the direction of air flowing out of the outer barrel 216.

As shown in FIG. 8A, the first array of outer openings 366A has a width W1 extending in a direction parallel to the rotation axis A and a height H1 extending transverse to the width W1. As shown in FIG. 8B, the second array of outer openings 366B has a width W2 extending in a direction parallel to the rotation axis A and a height H2 extending transverse to the width W2. The height H2 of the second array of outer openings 366B is equal to the height H1 of the first array of outer openings 366A, and the width W2 of the second array of outer openings 366B is less than the width W1 of the first array of outer openings 366A. More specifically, the width W2 of the second array of outer openings 366B is two-thirds the width W1 of the first array of outer openings 366A. In embodiments, the width W2 of the second array of outer openings 366B is equal to or greater than 50% and less than or equal to 80% the width W1 of the first array of outer openings 366A. In embodiments, the width W2 of the second array of outer openings 366B is equal to or greater than 60% and less than or equal to 70% the width W1 of the first array of outer openings 366A.

As shown in FIG. 8C, the third array of outer openings 366C has a width W3 extending in a direction parallel to the rotation axis A and a height H3 extending transverse to the width W3. The height H3 of the third array of outer openings 366C is equal to the height H2 of the second array of outer openings 366B, and the width W3 of the third array of outer openings 366C is less than the width W2 of the second array of outer openings 366B. More specifically, the width W3 of the third array of outer openings 366C is one-third the width W1 of the first array of outer openings 366A and about one-half the width W2 of the second array of outer openings 366B. In embodiments, the width W3 of the third array of outer openings 366C is equal to or greater than 20% and less than or equal to 40% the width W1 of the first array of outer openings 366A. In embodiments, the width W3 of the third array of outer openings 366C is equal to or greater than 30% and less than or equal to 40% the width W1 of the first array of outer openings 366A.

In embodiments, the first array of outer openings 366A is formed on a portion of the outer barrel body 352 diametrically opposing the third array of outer openings 366C. In embodiments, as shown in FIG. 8D, no outer openings 366 are formed on a portion of the outer barrel body 352 diametrically opposing the second array of outer openings 366B.

Referring again to FIG. 3, the inner barrel 218 is shown including a first inner barrel member 368 and a second inner barrel member 370. The first inner barrel member 368 and the second inner barrel member 370 may be joined in any suitable manner such as by, for example, fasteners, clips, brackets, and the like. Although the first inner barrel member 368 and the second inner barrel member 370 are depicted as two separate components, it should be appreciated that the first inner barrel member 368 and the second inner barrel member 370 may be an integrally formed, one-piece component. The inner barrel 218 includes an inner barrel body 372 having a first end wall 374 and a second end wall 376. As shown in FIG. 3, an opening 378 is formed in the first end wall 374 to permit air to enter the inner barrel 218. A reinforcement rib 380 extends across the opening 378 and an aperture 382 is formed in the reinforcement rib 380 to permit the stabilizing pin 288 extending from the cap 278 to rotatably secure the inner barrel 218. A shaft receiver 384 is provided on the second end wall 376 that engages the shaft 340 of the driven wheel 222 to facilitate rotation of the inner barrel 218 in response to rotation of the driven wheel 222. In embodiments, the shaft receiver 384 had a D-shape corresponding to an inner shape of the shaft 340 of the driven wheel 222 to inhibit rotation of the driven wheel 222 relative to the inner barrel 218. As illustrated herein, the inner barrel 218 is provided within an interior of the outer barrel 216. However, it should be appreciated that, in other embodiments, the outer barrel 216 may be provided within an interior of the inner barrel 218.

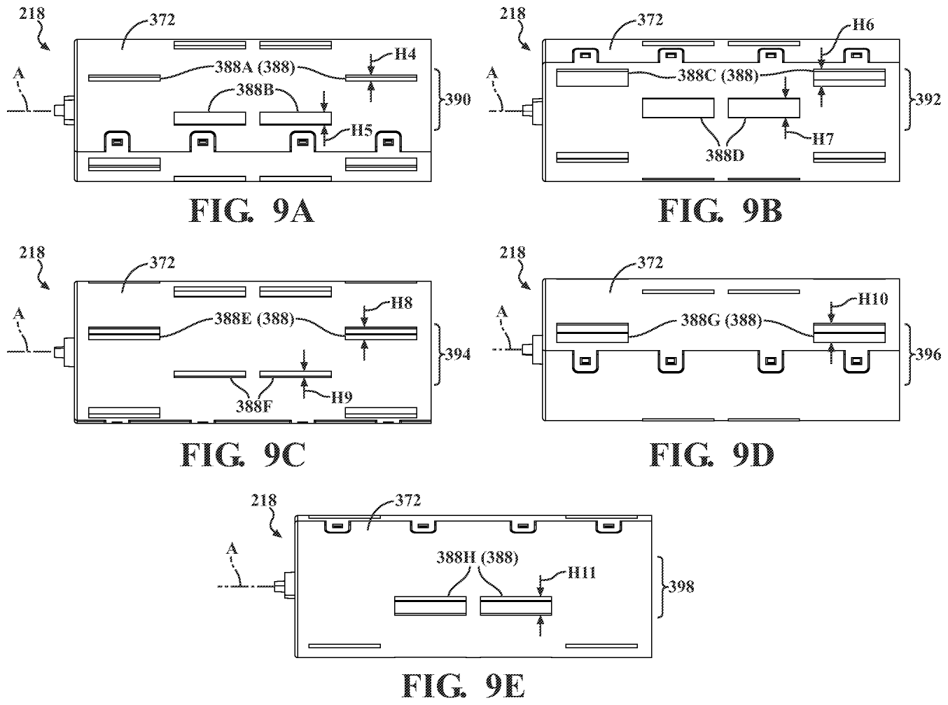

Referring now to FIGS. 9A-9E, the inner barrel is shown in various rotation positions. As noted herein, the inner barrel 218 includes the shaft receiver 384 and is rotatable about the rotation axis A. A plurality of inner openings 388 are formed in the inner barrel body 372 through which air may be permitted to flow through to exit the inner barrel 218 when aligned with one or both of the upper air outlets 234, 236 or the lower air outlets 262, 264. In order around the inner barrel 218 about the rotation axis A, the inner barrel body 372 includes a first region 390 (FIG. 9A), a second region 392 (FIG. 9B), a third region 394 (FIG. 9C), a fourth region 396 (FIG. 9D), and a fifth region 398 (FIG. 9E). As described in more detail herein, each region includes a combination of inner openings 388 to be aligned with the upper air outlets 234, 236 and/or the lower air outlets 262, 264 (FIG. 5).

As shown in FIG. 9A, the first region 390 of the inner barrel body 372 includes a first pair of upper inner openings 388A located at an axial position along the rotation axis A corresponding to the position of the upper air outlets 234, 236 (FIG. 5), and a first pair of lower inner openings 388B located at an axial position along the rotation axis A corresponding to the position of the lower air outlets 262, 264 (FIG. 5). The first pair of upper inner openings 388A have a height H4 extending in a direction transverse to the rotation axis A, and the first pair of lower inner openings 388B have a height H5 extending in a direction transverse to the rotation axis A. The height H5 of the first pair of lower inner openings 388B is one-half the height H4 of the first pair of upper inner openings 388A. In embodiments, the height H5 of the first pair of lower inner openings 388B is equal to or greater than 30% and less than or equal to 70% the height H4 of the first pair of upper inner openings 388A. In embodiments, the height H5 of the first pair of lower inner openings 388B is equal to or greater than 40% and less than or equal to 50% the height H4 of the first pair of upper inner openings 388A.

As shown in FIG. 9B, the second region 392 of the inner barrel body 372 includes a second pair of upper inner openings 388C located at an axial position along the rotation axis A corresponding to the position of the upper air outlets 234, 236 (FIG. 5), and a second pair of lower inner openings 388D located at an axial position along the rotation axis A corresponding to the position of the lower air outlets 262, 264 (FIG. 5). The second pair of upper inner openings 388C have a height H6 extending in a direction transverse to the rotation axis A, and the second pair of lower inner openings 388D have a height H7 extending in a direction transverse to the rotation axis A. The height H7 of the second pair of lower inner openings 388D is equal to the height H6 of the second pair of upper inner openings 388C. Additionally, the height H7 of the second pair of lower inner openings 388D and the height H6 of the second pair of upper inner openings 388C are each twice the height H5 of the first pair of lower inner openings 388B. In embodiments, the height H7 of the second pair of lower inner openings 388D and the height H6 of the second pair of upper inner openings 388C are equal to or greater than 150% and less than 250% the height H5 of the first pair of lower inner openings 388B. In embodiments, the height H7 of the second pair of lower inner openings 388D and the height H6 of the second pair of upper inner openings 388C are equal to or greater than 180% and less than 220% the height H5 of the first pair of lower inner openings 388B.

As shown in FIG. 9C, the third region 394 of the inner barrel body 372 includes a third pair of upper inner openings 388E located at an axial position along the rotation axis A corresponding to the position of the upper air outlets 234, 236 (FIG. 5), and a third pair of lower inner openings 388F located at an axial position along the rotation axis A corresponding to the position of the lower air outlets 262, 264 (FIG. 5). The third pair of upper inner openings 388E have a height H8 extending in a direction transverse to the rotation axis A, and the third pair of lower inner openings 388F have a height H9 extending in a direction transverse to the rotation axis A. The height H9 of the third pair of lower inner openings 388F is one-half the height H8 of the third pair of upper inner openings 388E. In embodiments, the height H9 of the third pair of lower inner openings 388F is equal to or greater than 30% and less than or equal to 70% the height H8 of the third pair of upper inner openings 388E. In embodiments, the height H9 of the third pair of lower inner openings 388F is equal to or greater than 40% and less than or equal to 50% the height H8 of the third pair of upper inner openings 388E. Additionally, the height H9 of the third pair of lower inner openings 388F is equal to the height H4 of the first pair of upper inner openings 388A. Moreover, the height H8 of the third pair of upper inner openings 388E is equal to the height H5 of the first pair of lower inner openings 388B.

As shown in FIG. 9D, the fourth region 396 of the inner barrel body 372 includes a fourth pair of upper inner openings 388G located at an axial position along the rotation axis A corresponding to the position of the upper air outlets 234, 236 (FIG. 5). The fourth pair of upper inner openings 388G have a height H10 extending in a direction transverse to the rotation axis A. The height H10 of the fourth pair of upper inner openings 388G is equal to the height H6 of the second pair of upper inner openings 388C and the height H7 of the second pair of lower inner openings 388D.

As shown in FIG. 9E, the fifth region 398 of the inner barrel body 372 includes a fifth pair of lower inner openings 388H located at an axial position along the rotation axis A corresponding to the position of the lower air outlets 262, 264 (FIG. 5). The fifth pair of lower inner openings 388H have a height H11 extending in a direction transverse to the rotation axis A. The height H11 of the fifth pair of lower inner openings 388H is equal to the height H10 of the fourth pair of upper inner openings 388G, the height H6 of the second pair of upper inner openings 388C, and the height H7 of the second pair of lower inner openings 388D. As used herein, the pairs of upper and lower inner openings 388A-388H may be collectively referred to as inner openings 388.

It should be appreciated that the inner barrel body 372 may have any number of regions other than that depicted herein. Additionally, each region may have any number of inner openings 388, each having various heights, other than that depicted herein. As described in more detail herein, it is the particular combination of inner openings 388 and outer openings 366 overlapping with a corresponding one or both of the pair of upper air outlets 234, 236 and the pair of lower air outlets 262, 264 that dictates the volume and location of airflow entering the blade member 204 (FIG. 2), and thus the volume and direction of airflow exiting the blade member 204 into the passenger compartment 102 of the vehicle 100 (FIG. 1).

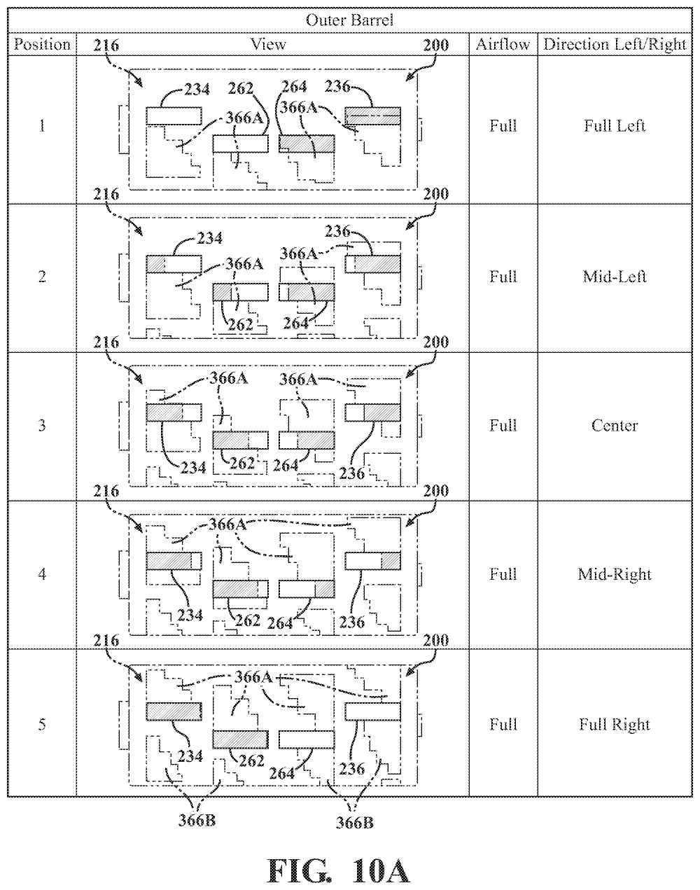

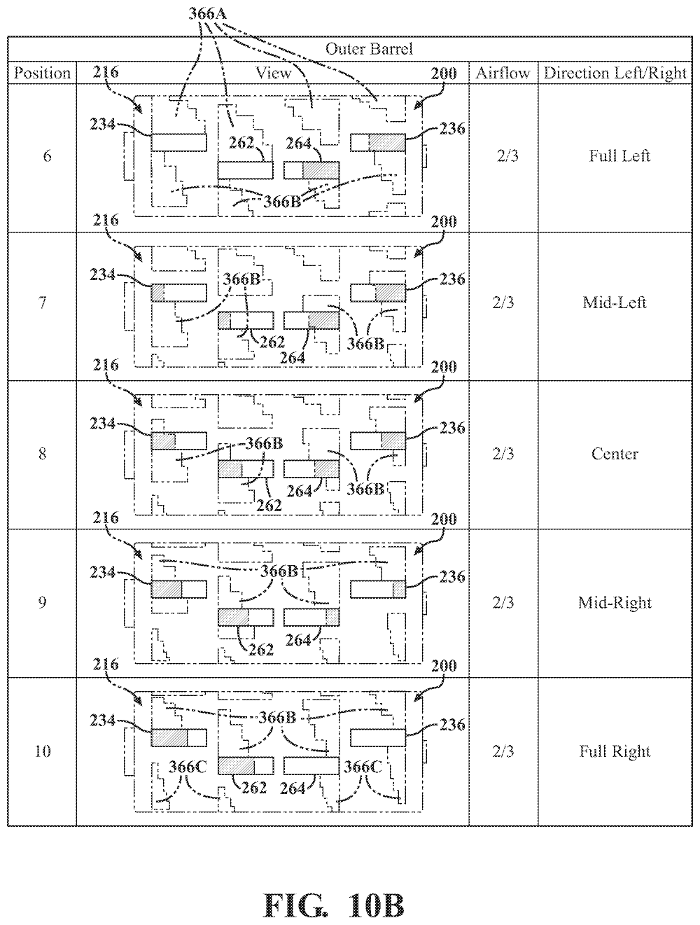

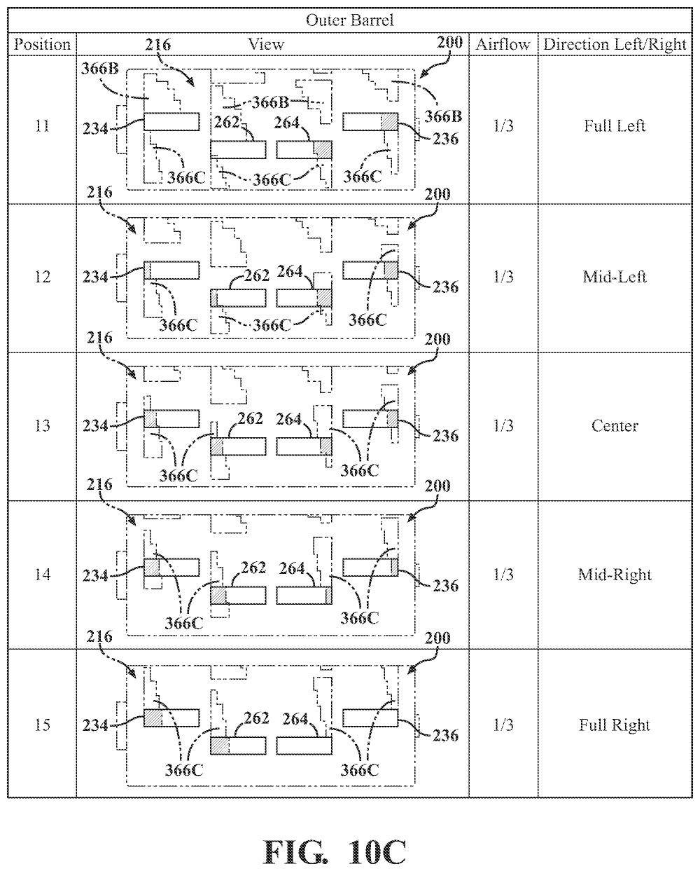

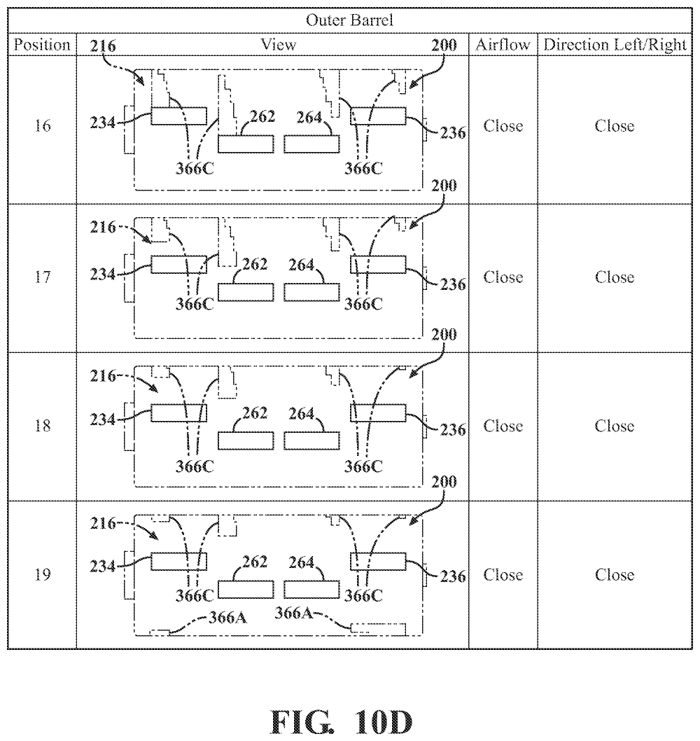

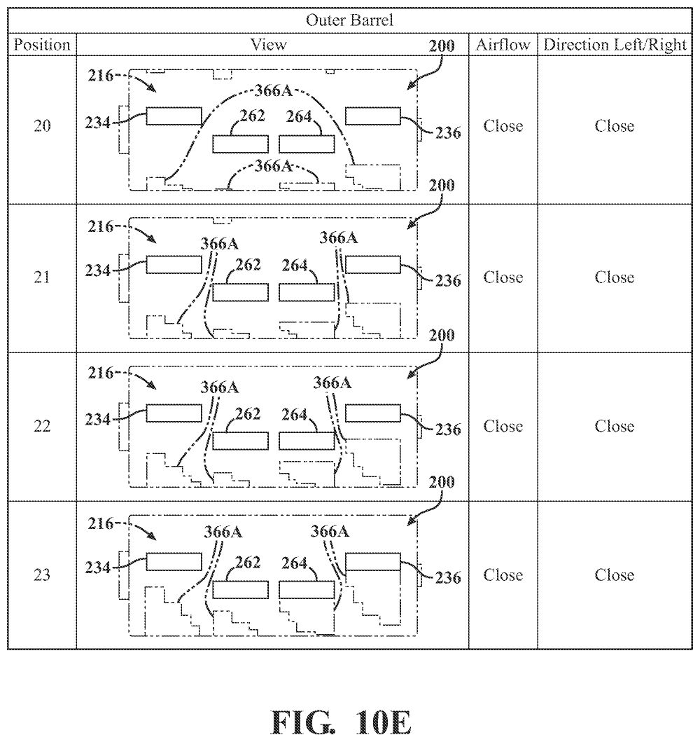

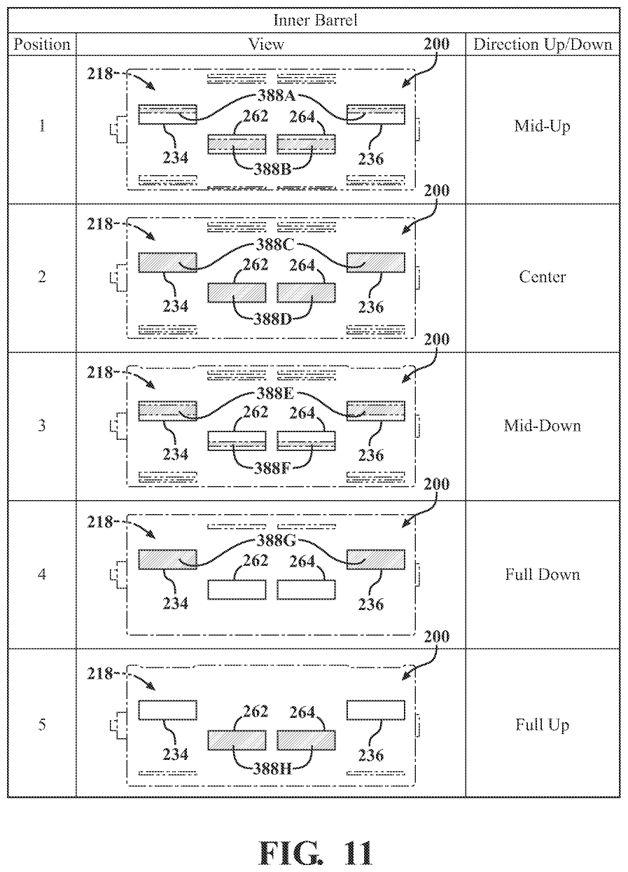

As described herein, the outer barrel 216 rotates with a 1:1 ratio of rotation with the drive wheel 220. With each incremental rotation of the drive wheel 220, the outer barrel 216 rotates to align a different portion of the outer openings 366 relative to the upper air outlets 234, 236 and the lower air outlets 262, 264. Referring now to FIGS. 10A-10E, tables are illustrated depicting each of the different possible positions of the outer barrel 216 relative to the housing 202. The tables includes a column indicating a position number (Outer Barrel Positions 1-23), a schematic view depicting a position of the outer openings 366 of the outer barrel 216 positioned relative to the upper air outlets 234, 236 and the lower air outlets 262, 264, a volume of airflow permitted (e.g., Full, ⅔, ⅓, Close), and a direction of airflow (e.g., Full Left, Mid-Left, Center, Mid-Right, Full Right, Close). In FIGS. 10A-10E, shading is used to illustrate what portion of the upper air outlets 234, 236 and the lower air outlets 262, 264 are open to the outer openings 366.

As shown in FIG. 10A, for example, Outer Barrel Position 1 illustrates one of the upper air outlets 234, 236 and one of the lower air outlets 262, 264 being completely opened to corresponding outer openings 366 of the first array of outer openings 366A. As such, in Outer Barrel Position 1, Full airflow is provided and directed to the Left (i.e., −X direction). Outer Barrel Position 2 illustrates each of the upper air outlets 234, 236 and each of the lower air outlets 262, 264 partially opened to corresponding outer openings 366 of the first array of outer openings 366A. As such, in Outer Barrel Position 2, Full airflow is provided and directed to the Mid-Left due to the volume of airflow to the left being greater than the volume of airflow to the right, which impedes the flow of airflow to the left. Outer Barrel Position 3 illustrates each of the upper air outlets 234, 236 and each of the lower air outlets 262, 264 partially opened to corresponding outer openings 366 of the first array of outer openings 366A. As such, in Outer Barrel Position 3, Full airflow is provided and directed to the Center (i.e., +Y direction) due to airflow from opposite upper air outlets 234, 236 and opposite lower air outlets 262, 264 being equal to and, thus, counteracting one another. Outer Barrel Position 4 illustrates each of the upper air outlets 234, 236 and each of the lower air outlets 262, 264 partially opened to corresponding outer openings 366 of the first array of outer openings 366A. As such, in Outer Barrel Position 4, Full airflow is provided and directed to the Mid-Right due to the volume of airflow to the right being greater than the volume of airflow to the left, which impedes the flow of airflow to the right. Outer Barrel Position 5 illustrates one of the upper air outlets 234, 236 and one of the lower air outlets 262, 264 being completely opened to corresponding outer openings 366 of the first array of outer openings 366A. As such, in Outer Barrel Position 5, Full airflow is permitted to exit the outer barrel 216 through the first array of outer openings 366A and directed to the Right (i.e., +X direction).

As shown in FIG. 10B, Outer Barrel Position 6 illustrates one of the upper air outlets 234, 236 and one of the lower air outlets 262, 264 being partially opened to corresponding outer openings 366 of the second array of outer openings 366B. As discussed herein, the second array of outer openings 366B have a width less than the width of the first array of outer openings 366A. As such, in Outer Barrel Position 6, a reduced two-thirds airflow compared to Outer Barrel Positions 1-5 is permitted to exit the outer barrel 216 through the second array of outer openings 366B and directed to the Left. Outer Barrel Positions 7-10 operate similar to Outer Barrel Positions 2-5.

As shown in FIG. 10C, Outer Barrel Position 11 illustrates one of the upper air outlets 234, 236 and one of the lower air outlets 262, 264 being partially opened to corresponding outer openings 366 of the third array of outer openings 366C. As discussed herein, the third array of outer openings 366C have a width less than the width of the second array of outer openings 366B. As such, in Outer Barrel Position 11, a reduced one-third airflow compared to Outer Barrel Positions 1-5 is permitted to exit the outer barrel 216 through the third array of outer openings 366C and directed to the Left. Outer Barrel Positions 12-15 operate similar to Outer Barrel Positions 2-5.

As shown in FIGS. 10D-10E, Outer Barrel Positions 16-23 illustrate various rotation positions of the outer barrel 216 in which none of the outer openings 366 are aligned with the upper air outlets 234, 236 and the lower air outlets 262, 264. Accordingly, in Outer Barrel Positions 16-23, no airflow is permitted to exit the outer barrel 216 through the openings 366.

Referring now to FIG. 11, a table is illustrated depicting each of the different possible Inner Barrel Positions of the inner barrel 218 relative to the housing 202. The table includes a column indicating a position number (Inner Barrel Positions 1-5), a schematic view depicting a position of the inner openings 388 of the inner barrel 218 positioned relative to the upper air outlets 234, 236 and the lower air outlets 262, 264, and a direction of airflow (e.g., Mid-up, Center, Mid-Down, Full Down, Full Up). In FIG. 11, shading is used to illustrate what portion of the upper air outlets 234, 236 and the lower air outlets 262, 264 are open to the inner openings 388.

Specifically, Inner Barrel Position 1 illustrates the first pair of upper inner openings 388A aligned with the upper air outlets 234, 236, and the first pair of lower inner openings 388B aligned with the lower air outlets 262, 264. As the volume of air permitted to flow through the first pair of lower inner openings 388B is greater than the volume of air permitted to flow through the first pair of upper inner openings 388A, the cumulative airflow is directed in the Mid-Up direction. Inner Barrel Position 2 illustrates the second pair of upper inner openings 388C aligned with the upper air outlets 234, 236, and the second pair of lower inner openings 388D aligned with the lower air outlets 262, 264. As the volume of air permitted to flow through the second pair of lower inner openings 388D is equal to the volume of air permitted to flow through the second pair of upper inner openings 388C, the cumulative airflow is directed in the Center direction. Inner Barrel Position 3 illustrates the third pair of upper inner openings 388E aligned with the upper air outlets 234, 236, and the third pair of lower inner openings 388F aligned with the lower air outlets 262, 264. As a volume of air permitted to flow through the third pair of upper inner openings 388E is greater than the volume of air permitted to flow through the third pair of lower inner openings 388F, the cumulative airflow is directed in the Mid-Down direction. Inner Barrel Position 4 illustrates the fourth pair of upper inner openings 388G aligned with the upper air outlets 234, 236. As the lower air outlets 262, 264 are not open to any inner openings 388, the cumulative airflow is directed in the Full Down direction. Inner Barrel Position 5 illustrates the fifth pair of lower inner openings 388H aligned with the lower air outlets 262, 264. As the upper air outlets 234, 236 are not open to any inner openings 388, the cumulative airflow is directed in the Full Up direction.

As described herein, the inner barrel 218 rotates with a 5:1 ratio of rotation with the drive wheel 220 and thus the outer barrel 216, and a 1:1 ratio of rotation with the driven wheel 222. With each incremental rotation of the driven wheel 222, the inner barrel 218 rotates to align a different portion of the inner openings 388 relative to the upper air outlets 234, 236 and the lower air outlets 262, 264. As such, any one of the Outer Barrel Positions 1-23 illustrated in the tables of FIGS. 10A-10E may be selected with any one of the Inner Barrel Positions 1-5 illustrated in the table of FIG. 11.

Specifically, for example, the Outer Barrel Position 1 (FIG. 10A), in which Full airflow is provided and directed to the Full Left (i.e. −X direction in the vehicle lateral direction) may be selected with Inner Barrel Positon 1 (FIG. 11), in which airflow is provided in the Mid-Up direction (i.e. +Z in the vehicle vertical direction). Additionally, for example, the Outer Barrel Position 7 (FIG. 10B), in which two-thirds airflow is provided and directed to the Mid-Left (i.e.-X direction in the vehicle lateral direction) may be selected with Inner Barrel Positon 2 (FIG. 11), in which airflow is provided in the Center direction. Additionally, for example, the Outer Barrel Position 13 (FIG. 10C), in which one-third airflow is provided and directed to the Center may be selected with Inner Barrel Positon 3, in which airflow is provided in the Mid-Down direction (i.e. −Z in the vehicle vertical direction).Additionally, for example, the Outer Barrel Position 16 (FIG. 10D), in which no airflow is provided in any direction may be selected with Inner Barrel Positon 4, in which airflow is provided in the Full-Down direction (i.e. −Z in the vehicle vertical direction).Additionally, for example, the Outer Barrel Position 20 (FIG. 10E), in which no airflow is provided in any direction may be selected with Inner Barrel Positon 5, in which airflow is provided in the Full-Up direction (i.e. +Z in the vehicle vertical direction).

It should be appreciated that the above examples of various combinations of the Outer Barrel Positions and the Inner Barrel Positions are non-limiting examples and other combinations are possible other than those specifically described herein. Accordingly, other combinations of positions are contemplated as being within the scope of the present disclosure. Additionally, it should be appreciated that each of the outer barrel 216 and the inner barrel 218 may be rotated in either direction to achieve the specific combination of positions in an efficient manner rather than each of the outer barrel 216 and the inner barrel 218 rotating in the same direction.

Referring again to FIG. 7, as described herein, the electronic control unit 346 transmits a signal to the actuation mechanism 206 to position the outer barrel 216 and the inner barrel 218 (FIG. 3) to a particular position. In embodiments, the electronic control unit 346 may receive a shut-down signal in response to the vehicle 100 being turned off. In response to receiving the shut-down signal, the electronic control unit 346 transmits the shut-down signal to the motor 344, which is then operated to rotate the drive wheel 220 such that none of the outer openings 366 and none of the inner openings 388 are aligned with the upper air outlets 234, 236, and thus the plurality of upper air channels 300, and the lower air outlets 262, 264, and thus the plurality of lower air channels 302. Accordingly, air is inhibited from flowing through the air register 200 in response to the vehicle 100 being turned off.

From the above, it is to be appreciated that defined herein is air registers including a housing, a blade member provided within the housing and defining a plurality of upper air channels and a plurality of lower air channels, an outer barrel having a plurality of outer openings, the outer barrel rotatable relative to the housing to align one or more of the plurality of outer openings with one or more of the plurality of upper air channels and one or more of the plurality of lower air channels, and an inner barrel having a plurality of inner openings, the inner barrel rotatable relative to the housing to align one or more of the plurality of inner openings with one or more of the plurality of upper air channels and one or more of the plurality of lower air channels.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An air register comprising:
a housing;
a blade member provided within the housing and defining a plurality of upper air channels and a plurality of lower air channels;
an outer barrel having a plurality of outer openings, the outer barrel rotatable relative to the housing to align one or more of the plurality of outer openings with one or more of the plurality of upper air channels and one or more of the plurality of lower air channels; and
an inner barrel having a plurality of inner openings, the inner barrel rotatable relative to the housing to align one or more of the plurality of inner openings with one or more of the plurality of upper air channels and one or more of the plurality of lower air channels.

2. The air register of claim 1, wherein:
the plurality of upper air channels are defined by a first subset of upper vanes and a second subset of upper vanes, the first subset of upper vanes extending in a direction opposite the second subset of upper vanes; and
the plurality of lower air channels are defined by a first subset of lower vanes and a second subset of lower vanes, the first subset of lower vanes extending in a direction opposite the second subset of lower vanes.

3. The air register of claim 2, wherein the blade member includes a central wall separating the plurality of upper air channels from the plurality of lower air channels, the central wall having an upper surface defining the plurality of upper air channels and a lower surface opposite the upper surface defining the plurality of lower air channels, the upper surface and the lower surface having an arcuate shape curving in opposite directions.

4. The air register of claim 1, wherein the inner barrel is positioned within the outer barrel.

5. The air register of claim 4, further comprising an actuation mechanism for rotating the outer barrel and the inner barrel, the actuation mechanism including:
a drive wheel rotatably coupled to the outer barrel; and
a driven wheel fixed to the inner barrel, the driven wheel operably coupled to the drive wheel.

6. The air register of claim 5, wherein the actuation mechanism is a Geneva drive.

7. The air register of claim 5, further comprising:
a motor coupled to the drive wheel; and
an electronic control unit communicatively coupled to the motor, the electronic control unit is configured to send a signal to the motor to rotate the drive wheel.

8. The air register of claim 5, further comprising:
a motor coupled to the drive wheel; and
an electronic control unit communicatively coupled to the motor, the electronic control unit is configured to, in response to receiving a shut-down signal, operate the motor to rotate the drive wheel such that no outer opening and no inner opening are aligned with the plurality of upper air channels and the plurality of lower air channels.

9. The air register of claim 1, wherein each of the plurality of outer openings have a width that decreases along a length of the respective outer opening.

10. The air register of claim 1, wherein the housing defines a pair of upper air outlets aligned with the plurality of upper air channels, and a pair of lower air outlets aligned with the plurality of lower air channels.

11. The air register of claim 1, wherein a volume and a direction of air exiting the blade member is selectively controllable based on a particular rotation position of the inner barrel and the outer barrel.

12. A vehicle comprising:
a dashboard; and
an air register provided within the dashboard, the air register comprising:
a housing;
a blade member provided within the housing and defining a plurality of upper air channels and a plurality of lower air channels;
an outer barrel having a plurality of outer openings, the outer barrel rotatable relative to the housing to align one or more of the plurality of outer openings with one or more of the plurality of upper air channels and one or more of the plurality of lower air channels; and
an inner barrel having a plurality of inner openings, the inner barrel rotatable relative to the housing to align one or more of the plurality of inner openings with one or more of the plurality of upper air channels and one or more of the plurality of lower air channels.

13. The vehicle of claim 12, wherein:
the plurality of upper air channels are defined by a first subset of upper vanes and a second subset of upper vanes, the first subset of upper vanes extending in a direction opposite the second subset of upper vanes; and
the plurality of lower air channels are defined by a first subset of lower vanes and a second subset of lower vanes, the first subset of lower vanes extending in a direction opposite the second subset of lower vanes.

14. The vehicle of claim 13, wherein the blade member includes a central wall separating the plurality of upper air channels from the plurality of lower air channels, the central wall having an upper surface defining the plurality of upper air channels and a lower surface opposite the upper surface defining the plurality of lower air channels, the upper surface and the lower surface having an arcuate shape curving in opposite directions.

15. The vehicle of claim 12, further comprising an actuation mechanism for rotating the outer barrel and the inner barrel, the actuation mechanism including:
a drive wheel rotatably coupled to the outer barrel; and
a driven wheel fixed to the inner barrel, the driven wheel operably coupled to the drive wheel.

16. The vehicle of claim 12, wherein each of the plurality of outer openings have a width that decreases along a length of the respective outer opening.

17. The vehicle of claim 12, wherein the housing defines a pair of upper air outlets aligned with the plurality of upper air channels, and a pair of lower air outlets aligned with the plurality of lower air channels.

18. The vehicle of claim 12, wherein a volume and a direction of air exiting the blade member is selectively controllable based on a particular rotation position of the inner barrel and the outer barrel.

19. A method of operating an air register comprising a housing, a blade member defining a plurality of upper air channels and a plurality of lower air channels, an outer barrel having a plurality of outer openings, and an inner barrel having a plurality of inner openings, the method comprising:
rotating the outer barrel relative to the housing to align one or more of the plurality of openings channels with one or more of the plurality of upper air channels and one or more of the plurality of lower air channels; and
rotating the inner barrel relative to the housing to align one or more of the plurality of inner openings with one or more of the plurality of upper air channels and one or more of the plurality of lower air channels,
wherein a volume and a direction of air exiting the blade member is selectively controllable based on a particular rotation position of the inner barrel and the outer barrel.

20. The method of claim 19, further comprising rotating a drive wheel rotatably coupled to the outer barrel to rotate the outer barrel, the drive wheel rotatably coupled to a driven wheel fixed to the inner barrel such that rotation of the drive wheel rotates the inner barrel.
